(19) United States
(12) Patent Application Publication
(10) Pub. No.: US 2020/0336493 A1
(43) Pub. Date: Oct. 22, 2020

(54) SERVER AND OPERATING METHOD THEREOF

(71) Applicant: HYPERCONNECT, INC., Seoul (KR)

(72) Inventors: Sangil Ahn, Cheongju-si (KR); Kangsik Jung, Seoul (KR)

(73) Assignee: HYPERCONNECT, INC., Seoul (KR)

(21) Appl. No.: 16/851,248

(22) Filed: Apr. 17, 2020

(30) Foreign Application Priority Data
Apr. 18, 2019 (KR) 10-2019-0045265

(51) Int. Cl. H04L 29/06; H04L 29/12; H04W 12/00

(52) U.S. Cl. CPC H04L 63/107; H04L 65/1063; H04W 12/00503; H04L 63/0876; H04W 12/00514; H04L 61/609

(57) ABSTRACT

A server may include a communication interface for receiving a log in request for a video call service from a terminal, and for receiving at least one information to be used to determine a country of a log in attempt from the terminal; a memory for storing country information received from the terminal when subscribing the video call service of the terminal; and a processor for determining the country of the log in attempt of the terminal based on the at least one information, comparing a prestored country information corresponding to the terminal with the determined country of the log in attempt, and allowing the log in of the terminal depending on a result of the comparison.

### CROSS-REFERENCE TO THE RELATED APPLICATION

This application is based on and claims priority from Korean Patent Application No. 10-2019-0045265 filed on Apr. 18, 2019 in the Korean Intellectual Property Office, the disclosure of which is incorporated herein in its entirety by reference.

### BACKGROUND

### 1. Field

The present disclosure relates to a server and an operating method thereof, and more particularly, to a server that restricts the use of a service by a user when a country where a log in attempt is made does not match a country information input when subscribing the service, and an operating method thereof.

### 2. Description of the Related Art

With the development of communication technology and the miniaturization of electronic devices, personal terminals are being widely spread among general consumers. In particular, in recent years, portable personal terminals such as smart phones or smart tablets have been widely used. Most terminals include image photographing technology. Users can use terminals to photograph images that include various contents.

There are various types of video call services that are based on video calls. For example, a random video chat service is a service that connects the terminal of a user who has made a request to use the random video chat service with the terminal of a randomly selected user among users using the random video chat service.

In order to provide various types of video call services with good quality, a method of restricting the use of a video call service may be required for users who attempt intentional cheating with the video call service.

### SUMMARY

A purpose of the present disclosure is to provide a server and an operating method thereof, that restricts the service use of a user when the country where the user made a log in attempt does not match the country information input when subscribing the service.

An operating method of a server for providing a video call service according to an embodiment of the present disclosure may include receiving a log in request for the video call service from a terminal; requesting at least one information to be used in determining a country of a log in attempt of the terminal; receiving the at least one information from the terminal; determining the country of the log in attempt of the terminal based on the at least one information; comparing a prestored country information corresponding to the terminal and the determined country of the log in attempt; and allowing the log in of the terminal depending on a result of the comparison.

In some embodiments, the at least one information may include Internet Protocol (IP) address information, Subscriber Identity Module (SIM) information, and Global Positioning System (GPS) information.

In some embodiments, the determining the country of the log in attempt of the terminal based on the at least one information may include extracting a first country information from the IP address information, extracting a second country information from the SIM information, and extracting a third country information from the GPS information.

In some embodiments, the determining the country of the log in attempt of the terminal based on the at least one information may further include, in response to the first country information, the second country information and the third country information all being identical to one another, determining the country included in the first to third country information as the country of the log in attempt.

In some embodiments, the determining the country of the log in attempt of the terminal based on the at least one information may further include, in response to two or more of the first country information, the second country information, and the third country information including an identical country, determining the country included in the two or more information as the country of the log in attempt.

In some embodiments, the determining the country of the log in attempt of the terminal based on the at least one information may further include, in response to the first country information, the second country information, and the third country information being different from one another, giving each of the first to third country information a weight of different value, and determining the country included in the country information to which the weight is given as the country of the log in attempt.

In some embodiments, the stored country information may be information input by a user of the terminal when subscribing the video call service.

In some embodiments, the stored country information may be information determined using at least one of IP information, GPS information, and SIM information input by a user of the terminal when subscribing the video call service.

In some embodiments, the allowing the log in of the terminal depending on a result of the comparison may include, in response to the stored country information and the determined country of the log in attempt being identical to each other as the result of the comparison, allowing the log in of the terminal.

In some embodiments, the operating method of a server for providing a video call service, may further include, in response to the stored country information and the determined country of the log in attempt being non-identical to each other as the result of the comparison, blocking the log in of the terminal.

In some embodiments, the operating method of a server for providing a video call service, may further include, in response to the stored country information and the determined country of the log in attempt being non-identical to each other as the result of the comparison, requesting at least one additional information to be used to determine the country of the log in attempt of the terminal; determining the country of the log in attempt of the terminal based on the at least one additional information; comparing the stored country information and the determined country of the log in attempt whether they are identical to each other; and allowing the log in of the terminal depending on the result of the comparison.

In some embodiments, the at least one additional information may include time information set in the terminal, and locale information including country and language information set in the terminal.

In some embodiments, the determining the country of the log in attempt of the terminal based on the at least one additional information may include extracting at least one fourth country from the time information, and extracting a fifth country from the locale information.

In some embodiments, the determining the country of the log in attempt of the terminal based on the at least one additional information may further include, in response to the at least one fourth country information and the fifth country information being identical to each other, determining the country included in the fourth country information and the fifth country information as the country of the log in attempt of the terminal.

In some embodiments, the allowing the log in of the terminal depending on the result of the comparison may include, in response to the stored country information and the determined country of the log in attempt being identical to each other as the result of the comparison, allowing the log in of the terminal.

In some embodiments, the operating method of a server for providing a video call service, may further include, in response to the stored country information and the determined country of the log in attempt being non-identical to each other as the result of the comparison, blocking the log in of the terminal.

A server according to an embodiment of the present disclosure may include a communication interface for receiving a log in request for a video call service from a terminal, and for receiving at least one information to be used to determine a country of a log in attempt from the terminal; a memory for storing country information received from the terminal when subscribing the video call service of the terminal; and a processor for determining the country of the log in attempt of the terminal based on the at least one information, comparing a prestored country information corresponding to the terminal with the determined country of the log in attempt, and allowing the log in of the terminal depending on a result of the comparison.

### BRIEF DESCRIPTION OF THE DRAWINGS

FIG. 1 is a network configuration diagram illustrating an environment where an electronic device operates according to an embodiment of the present disclosure;

FIG. 2 is a block diagram illustrating a configuration of a terminal according to an embodiment of the present disclosure;

FIG. 3 is a block diagram illustrating a configuration of a server according to an embodiment of the present disclosure;

FIG. 4 is a block diagram illustrating an operating method of the server according to an embodiment of the present disclosure;

FIG. 5 is a view illustrating a method in which the server allows the log in of the terminal according to an embodiment of the present disclosure;

FIG. 6 is a view illustrating a method in which the server allows the log in of the terminal according to another embodiment of the present disclosure;

FIG. 7 is a view illustrating a method in which the server allows the log in of the terminal according to another embodiment of the present disclosure;

FIG. 8 is a view illustrating a method in which the server blocks the log in of the terminal according to an embodiment of the present disclosure;

FIG. 9 is a view illustrating a method in which the server blocks the log in of the terminal according to another embodiment of the present disclosure;

FIG. 10 is a view illustrating a method in which the server blocks the log in of the terminal according to another embodiment of the present disclosure;

FIG. 11 is a block diagram illustrating an operating method of the server according to another embodiment of the present disclosure;

FIG. 12 is a view illustrating a method in which the server allows the log in of the terminal using additional information according to an embodiment of the present disclosure; and

FIG. 13 is a view illustrating a method in which the sever blocks the log in of the terminal using additional information according to embodiment of the present disclosure.

### DETAILED DESCRIPTION

The advantages and characteristics of the present disclosure, and the method for achieving those advantages and characteristics will be clarified with reference to the embodiments that will be explained hereinafter together with the drawings attached hereto. However, the present disclosure is not limited to the embodiments disclosed hereinafter, but may be implemented in various different forms, and the present embodiments are provided merely for the purpose of complete disclosure of the present disclosure, and for the purpose of informing a person skilled in the art of the complete scope of the present disclosure, and the present disclosure is to be defined only by the scope of the claims. Like reference numerals indicate like configurative elements through the entirety of the specification.

Even though “a first” or “a second” and the like are used to describe various configurative elements, these configurative elements are not limited by the aforementioned terms. The aforementioned terms can only be used to differentiate one configurative element from other configurative elements. Therefore, a first configurative element mentioned hereinafter may be a second configurative element within the technical idea of the present disclosure.

The terms used in the present specification were used to describe the embodiments, and not to limit the present disclosure. In the present specification, a singular form includes plural forms unless specially mentioned otherwise. “Comprises” or “comprising” used in the present specification imply that the mentioned configurative element or step does not exclude the presence or addition of one or more other configurative element or step.

Unless defined otherwise, all the terms used in the present specification may be construed to mean what may be commonly understood by a person skilled in the art. Further, the terms defined in generally used dictionaries should not be construed ideally or overly unless clearly defined specially.

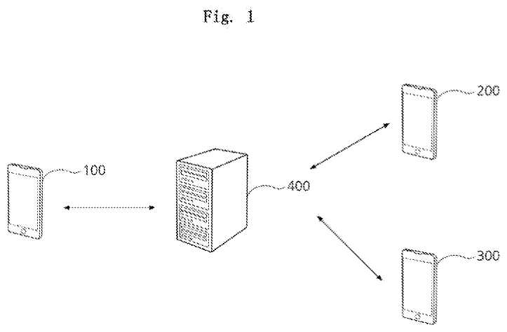

FIG. 1 is a network configuration diagram illustrating an environment where an electronic device operates according to an embodiment of the present disclosure. Referring to FIG. 1, the environment where a plurality of electronic devices 100˜300 operate may include a server 400 and the plurality of electronic devices 100˜300. For example, the environment where the plurality of electronic devices 100˜300 operate may not include the server 400.

Each of the plurality of electronic devices 100˜300 may be connected by medium of the server 400. For convenience of describing the present disclosure, three electronic devices are illustrated in FIG. 1. However, the number of the electronic devices is not limited to three. Each of the plurality of electronic devices 100˜300 may be implemented as one of a desktop computer, laptop computer, smart phone, smart tablet, smart watch, mobile terminal, digital camera, wearable device, or portable electronic device. Each of the plurality of electronic devices 100˜300 may execute a program or an application.

Each of the plurality of electronic devices 100˜300 may be connected to a communication network. Each of the plurality of electronic devices 100˜300 may be interconnected or connected to the server 400 through the communication network. Each of the plurality of electronic devices 100˜300 may output data to another interconnected device or receive data from the other interconnected device.

The communication network connected to each of the plurality of electronic devices 100˜300 may include a wired communication network, a wireless communication network, or a composite communication network. The communication network may include a mobile communication network such as 3G, LTE or LTE-A, etc. The communication network may include a wired or wireless communication network such as Wi-Fi, UMTS/GPRS, or Ethernet, etc. The communication network may include a local area communication network such as Magnetic Secure Transmission (MST), Radio Frequency IDentification (RFID), Near Field Communication (NFC), ZigBee, Z-Wave, Bluetooth, Bluetooth Low Energy (BLE), or InfraRed communication (IR), etc. The communication network may include Local Area Network (LAN), Metropolitan Area Network (MAN), or Wide Area Network (WAN), etc.

The plurality of electronic devices 100˜300 may exchange messages, files, audio data, images, or videos with each other. For example, the plurality of electronic devices 100˜300 may establish a video call session with each other using Transmission Control Protocol (TCP), User Datagram Protocol (UDP), or Web Real-Time Communication (WebRTC), etc.

The video call session may be established directly between at least two electronic devices of the plurality of electronic devices 100˜300. According to another embodiment, the video call session may be established between at least two electronic devices of the plurality of electronic devices 100˜300 via at least one other device. For example, the video call session may include a session established between the first electronic device 100 and the server 400, and a session established between the server 400 and the second electronic device 200.

The server 400 may connect the plurality of electronic devices 100˜300 so that they can perform communication with each other. For example, the server 400 may provide a video call service so that the plurality of electronic devices 100˜300 can establish the video call session. The server 400 may receive a match request from each of the plurality of electronic devices 100˜300. In response to the match request, the server 400 may match the plurality of electronic devices 100˜300.

The server 400 may receive a log in request from the plurality of electronic devices 100˜300. The server 400 may request information for determining a log in country from the plurality of electronic devices 100˜300. Based on the information, the server 400 may determine a location of the country in which each of the plurality of electronic devices 100˜300 attempts the log in, and may compare the location of the country of the log in attempt with the information of the country received from the plurality of electronic devices 100˜300 when subscribing the video call service. The server 400 may determine whether to allow the log in of the plurality of electronic devices 100˜300 depending on a result of the comparison. A method in which the server 400 determines whether to allow the log in of the plurality of electronic devices 100˜300 will be described in detail below with reference to the drawings.

Hereinbelow, for convenience of describing the present disclosure, an electronic device and a terminal may be used to have the same meaning.

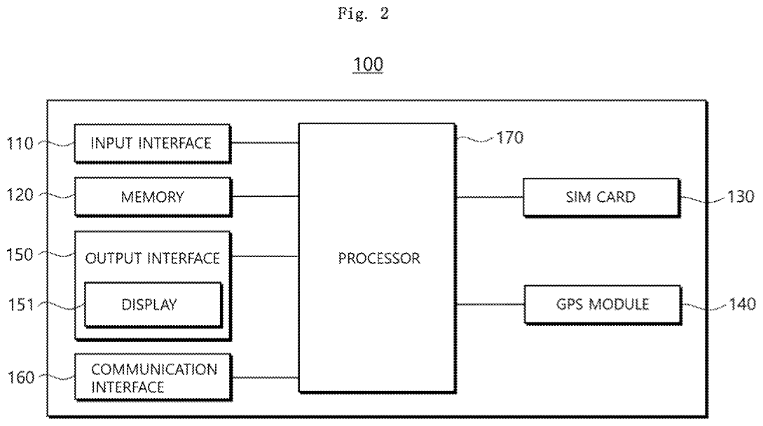

FIG. 2 is a block diagram illustrating a configuration of the terminal according to an embodiment of the present disclosure. Referring to FIG. 2, a first terminal 100 may include an input interface 110, a memory 120, a Subscriber Identification Module (SIM), card 130, a Global Positioning System (GPS) module 140, an output interface 150, a communication interface 160, and a processor 170. A second terminal 200 and a third terminal 300 illustrated in FIG. 1 may each be implemented similarly or identically as the first terminal 100.

The input interface 110 may receive signals from outside. The input interface 110 may receive the signals from a user of the terminal 100. Further, the input interface 110 may receive the signals from an external device. The input interface 110 may include, for example, a microphone, a camera, a keyboard, a mouse, a trackball, a touchscreen, a button, a switch, a sensor, a network interface, or other input devices, etc. The input interface 110 may receive voice from outside through the microphone included in the input interface 110.

Further, the input interface 110 may receive images photographed from the camera (not illustrated) included in the input interface 110, or receive gestures from the user of the terminal 100. Otherwise, the touchscreen included in the input interface 110 may receive touch inputs from the user of the terminal 100. The input interface 110 may receive user information or user inputs received from the user of the terminal 100. For example, the user information may include at least one of hobby information, gender information, country information, or age information of the user of the terminal 100. In addition, the user input may be a touch input received from the user of the terminal 100.

The memory 120 may store data. The memory 120 may store the voice or image data received from the input interface 110. In addition, the memory 120 may store results of computation performed by the processor 170. For example, the memory 120 may store a voice encoded by the processor 170. The memory 120 may store the data to be output externally through the communication interface 160, or store the data received from outside through the communication interface 160.

The memory 120 may store the user information or user input information received through the input interface 110. The memory 120 may store the country information of the user of the terminal 100 received through the input interface 110.

The memory 120 may store a software or a program. For example, the memory 120 may store programs and various types of data such as an application, and an Application Programming Interface (API), etc. The memory 120 may store instructions that are executable by the processor 170.

The memory 120 may include at least one of a volatile memory or a nonvolatile memory. The memory 120 may include at least one of, for example, flash memory, Read Only Memory (ROM), Random Access Memory (RAM), Electrically Erasable ROM (EEROM), Erasable Programmable ROM (EPROM), Electrically Erasable Programmable ROM (EEPROM), Hard Disk Drive (HDD), or register. The memory 120 may include, for example, a file system, a database, or an embedded database, etc.

A SIM card 130 may be mounted on the terminal 100 of a Group Special Mobile (GSM) method in order to authenticate the user. The SIM card 130 stores subscriber information of the terminal 100, and the subscriber information may include the country information. More specifically, the SIM card 130 may store the subscriber information using an International Mobile Subscriber Identity (IMSI). In addition, the IMSI may include the country information using Mobile Country Codes (MCC). For example, the MCC code of the Republic of Korea may be 450, the MCC code of Japan may be 440 and 441, and the MCC code of the United States may be 310-316. The SIM card 130 may transmit the SIM information that includes the country information of the terminal 100 subscriber, to the processor 170. In the present embodiment, it is described that the subscriber identification card is the SIM card 130, but a Universal SIM (USIM) card may be applied as well. The subscriber of the terminal 100 and the user of the terminal 100 may be used to have the same meaning.

The GPS module 140 may perform a function of collecting information related to the location of the current terminal 100 using the GPS function. For example, the GPS module 140 may collect GPS coordinates, and transmit the collected information to the processor 170.

The output interface 150 may include a display 151. The display 151 may display a screen. The display 151 may display a user interface. The display 151 may display another screen in response to an input from the user.

The display 151 may display data. The display 151 may display the result of computation performed by the processor 170. The display 151 may display the data stored in the memory 120. The display 151 may display the data received by the communication interface 160. For example, the display 151 may display the image received from the input interface 110.

For example, the display 151 may include a flat panel display device such as Liquid Crystal Display (LCD), Organic Light Emitting Diode (OLED), or Plasma Display Panel (PDP), etc. The display 151 may include a curved-surface display or a flexible display. The display 151 may include a touchscreen. In a case where the display 151 includes the touchscreen, the display 151 may operate as the input interface 110 at the same time as performing the output operations.

The output interface 150 may output sound. The output interface 150 may output the sound received through the input interface 110 or the sound received through an external device. For example, the output interface 150 may include a speaker.

The communication interface 160 may output data to outside of the terminal 100 or receive data from the outside. The communication interface 160 may output the data to the server 400 or to an external device. The communication interface 160 may receive the data from the server 400 or from the external device. The communication interface 160 may output the result of computation performed by the processor 170, to the outside.

The communication interface 160 may output information used for determining the country where the user of the terminal 100 is located, to the server 400. Otherwise, the communication interface 160 may output the user information or the user input information stored in the memory 120, to the server 400.

The communication interface 160 may include, for example, a remote network interface such as 3G module, LTE module, LTE-A module, Wi-Fi module, WiGig module, Ultra Wide Band (UWB) module, or LAN card, etc. Further, the communication interface 160 may include a local area network interface such as Magnetic Secure Transmission (MST) module, Bluetooth module, NFC module, RFID module, ZigBee module, Z-Wave module, or infrared ray module, etc. Further, the communication interface 160 may include other network interfaces.

The processor 170 or each of the configuration elements included in the processor 170 may be implemented in the form of software or hardware. For example, the software may be implemented as program execution instructions such as mechanical codes, firmware codes, embedded codes, and applications, etc. The hardware may be an electric electronic circuit, processor, computer, pressure sensor, inertia sensor, MicroElectroMechanical System (MEMS), passive elements, or a combination thereof.

The processor 170 may control operations of the terminal 100. The processor 170 may be interconnected with each of the configuration elements included in the terminal 100, and may control the operations of each of the configuration elements included in the terminal 100. The processor 170 may control the operations of the terminal 100 in response to the signal received by the input interface 110.

The processor 170 may collect information from which the country where the terminal 100 is located, can be inferred. For example, the processor 170 may read an Internet Protocol (IP) address received from the communication interface 160. The processor 170 may obtain the SIM information that includes the country information, from the SIM card 130. Otherwise, the processor 170 may obtain the GPS information that includes the location information of the terminal 100, from the GPS module 140. Additionally, the processor 170 may obtain time information and locale information set in the terminal 100. According to a request of the server 400, the processor 170 may output at least one of the IP information, SIM information, GPS information, time information, and locale information, through the communication interface 160.

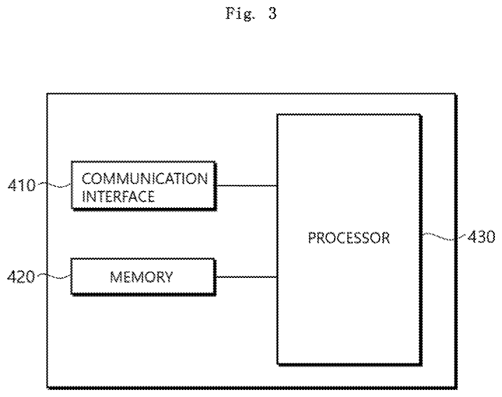

FIG. 3 is a block diagram illustrating a configuration of the server according to an embodiment of the present disclosure. Referring to FIGS. 1 and 3, the server 400 may include a communication interface 410, a memory 420, and a processor 430.

The communication interface 410 may output data to outside of the server 400, or receive data from the outside. The communication interface 410 may output the data to the plurality of terminals 100˜300, and receive the data from the plurality of terminals 100˜300. The communication interface 410 may output the result of computation performed by the processor 430, to the outside. Further, the communication interface 410 may output the data stored in the memory 420, to the outside.

The communication interface 410 may receive information from which the country can be inferred, from at least one of the plurality of terminals 100˜300. The data to be output by the communication interface 410, or the data received by the communication interface 410 may be stored in the memory 420.

The communication interface 410 may include, for example, a remote network interface such as 3G module, LTE module, LTE-A module, Wi-Fi module, WiGig module, Ultra Wide Band (UWB) module, or LAN card, etc. Further, the communication interface 410 may include a local area network interface such as Magnetic Secure Transmission (MST) module, Bluetooth module, NFC module, RFID module, ZigBee module, Z-Wave module, or infrared ray module, etc. Further, the communication interface 410 may include other network interfaces.

The memory 420 may store programs and various types of data such as an application, and an application programming interface (API), etc. The memory 420 may store instructions that are executable by the processor 430. For example, the application may be an application that can provide video call services to the plurality of terminals 100˜300.

The memory 420 may store the information received through the communication interface 410. For example, the memory 420 may store the country information input by each user of the plurality of terminals 100˜300 when subscribing the application, and the information from which the country can be inferred, received from at least one of the plurality of terminals 100˜300.

The memory 420 may include at least one of a volatile memory or a nonvolatile memory. The memory 420 may include at least one of, for example, flash memory, ROM, EEROM, EPROM, EEPROM, Hard Disk Drive or register. The memory 420 may include, for example, a file system, a database, or an embedded database, etc.

The processor 430 or each of the configuration elements included in the processor 430 may be implemented in the form of software or hardware. For example, the software may be implemented as program execution instructions such as mechanical codes, firmware codes, embedded codes, and applications, etc. The hardware may be an electric electronic circuit, processor, computer, pressure sensor, inertia sensor, MEMS, passive elements, or a combination thereof.

The processor 430 may execute the instructions and application stored in the memory 420. For example, the processor 430 may determine whether to accept the log in request of the plurality of terminals 100˜300 by executing the application. For example, when the log in request is received from at least one of the plurality of terminals 100˜300, the processor 430 may compare the country information stored in the memory 420 with the information from which the country can be inferred, received from the terminal that requested the log in, and determine whether to accept the log in request. However, the type of the contents included in an image received from at least one, may be identified.

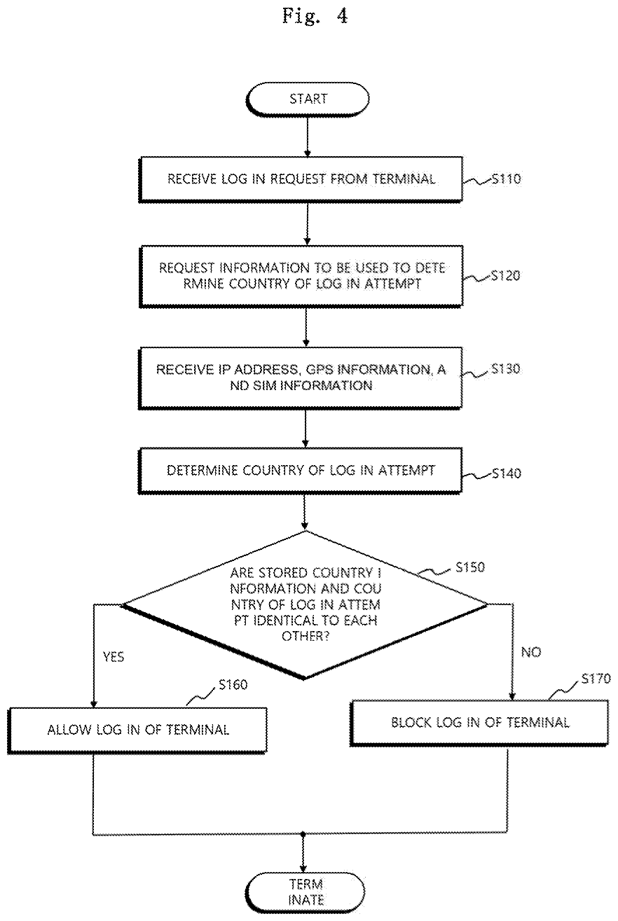

The detailed operating method of the server 400 may be described with reference to FIGS. 4 to 13.

FIG. 4 is a block diagram illustrating an operating method of the server according to an embodiment of the present disclosure. At step S110, the communication interface 410 of the server 400 may receive a log in request from the first terminal 100. To describe the present disclosure, it is assumed that the first terminal 100 is the first terminal 100. For example, the server 400 may execute an application that provides video call services through the communication interface 410.

At step S120, the processor 430 of the server 400 may request information for determining in which country the first terminal 100 attempted to log in. The processor 430 may transmit the request to the first terminal 100 through the communication interface 410.

At step S130, in response to the request, the processor 430 of the server 400 may receive IP address, GPS information, and SIM information from the first terminal 100. The IP address, GPS information, and SIM information may be received through the communication interface 410 of the server 400.

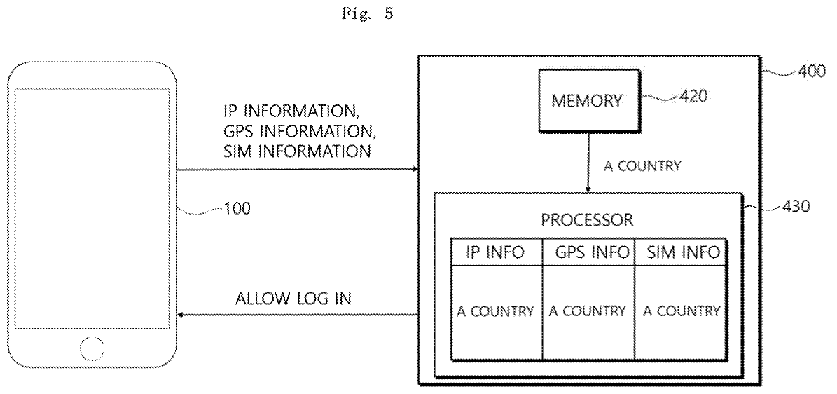

At step S140, the processor 430 of the server 400 may determine the country in which the first terminal 100 made the log in attempt based on the received information. More specifically, the processor 430 may determine the country of the log in attempt of the first terminal 100 based on the IP address, GPS information, and SIM information. The method in which the processor 430 determines the country of the log in attempt of the terminal 100 will be described with reference to FIGS. 5 to 10.

At step S150, the processor 430 of the server 400 may check whether the country information stored in the memory 420 and the determined country information are identical to each other. If the stored country information and the determined country information are identical to each other, at step S160, the processor 430 of the server 400 may allow the log in of the first terminal 100. On the contrary, in a case where the stored country information and the determined country information are different from each other, at step S170, the processor 430 of the server 400 may block the log in of the first terminal 100.

As described with reference to FIG. 4, the present disclosure provides a method for restricting the use of a service by a user when the country in which a log in attempt is made is not identical to the country information input when subscribing the service. Therefore, the server and operating method thereof according to the present disclosure may have an effect of blocking the log in of a terminal user who attempts to fake the country and log in to receive the benefits provided to users of a specific country.

FIG. 5 is a view illustrating a method in which the server allows the log in of a terminal according to an embodiment of the present disclosure. Referring to FIGS. 3 to 5, at a request of the server 400, the terminal 100 my transmit information for determining the country of the log in attempt, to the server 400. For example, the information used to determine the country of the log in attempt may be IP information, GPS information, and SIM information of the terminal 100.

The IP address may be an address playing the role of a locator that shows the location of the terminal 100. From the received IP information, the processor 430 may extract information of a region where the terminal 100 is located. For example, the regional information extracted from the IP information may be ‘A country’.

The processor 430 may extract the GPS coordinates from the GPS information. The processor 430 may change the extracted GPS coordinates into an address of a text format, that includes at least one of name of country, name of city, name of suburb and street number. For example, the regional information extracted from the GPS information may be ‘A country’.

The processor 430 may extract the country information from the SIM information. For example, the country information extracted from the SIM information may be ‘A country’.

The processor 430 may extract the information of the country where the terminal 100 is located, from each of the IP information, GPS information, and SIM information. In an embodiment of the present disclosure, the information of the country where the terminal 100 is located and the country of the log in attempt of the terminal 100 may be used to have the same meaning.

The processor 430 may compare each information to determine the country of the log in attempt of the terminal 100. Since the country information extracted from each of the IP information, GPS information, and SIM information is ‘A country’, the processor 430 may determine the country of the log in attempt of the terminal 100 as ‘A country’.

In order to determine whether to allow the log in of the terminal 100, the processor 430 may read the country information received from the terminal 100 when subscribing the video call service, from the memory 420. For example, the country information read from the memory 420 may be the country information input from the user of the terminal 100 when subscribing the video call service. In another example, the country information read from the memory 420 may be the country information determined using at least one of the IP information, GPS information, and SIM information, received from the terminal 100 when subscribing the video call service.

The processor 430 may compare the country of the log in attempt of the terminal 100 with the country information read from the memory 420. For example, the country information read from the memory 420 may be ‘A country’. The processor 430 may check that the country of the log in attempt of the terminal 100 and the read country information are both ‘A country’. Therefore, the processor 430 may allow the log in of the terminal 100.

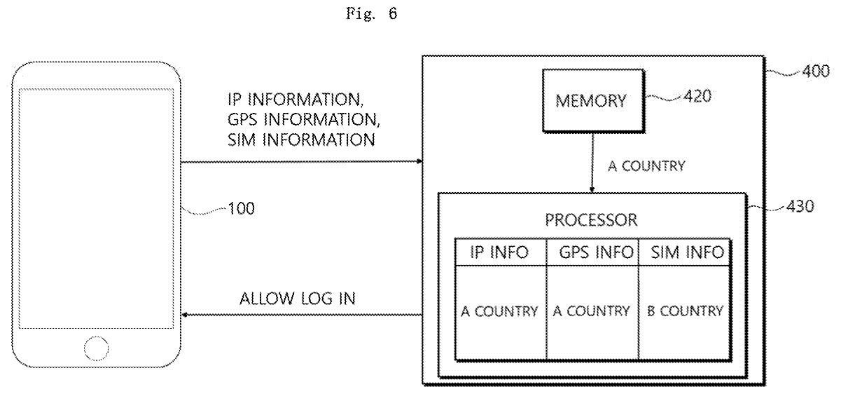

FIG. 6 is a view illustrating a method in which the server allows the log in of the terminal according to another embodiment of the present disclosure.

Referring to FIGS. 3, 4, and 6, at a request of the server 400, the terminal 100 may transmit the information for determining the country of the log in attempt, to the server 400. For example, the information for determining the country of the log in attempt may be the IP information, GPS information, and SIM information of the terminal 100.

From the received IP information, the processor 430 may extract the information of the region where the terminal 100 is located. For example, the regional information extracted from the IP information may be ‘A country’. The processor 430 may extract the GPS coordinates from the GPS information. For example, the regional information extracted from the GPS information may be ‘A country’. In addition, the processor 430 may extract the country information from the SIM information. For example, the country information extracted from the SIM information may be ‘B country’.

The country information extracted from each of the IP information and GPS information may be ‘A country’, and the country information extracted from the SIM information may be ‘B country’. In some embodiments, in a case where there are two or more country information extracted, the processor 430 may select one of the two or more country information as the country of the log in attempt of the terminal 100. For example, the processor 430 may select the country information, which is the same among the most number of the two or more country information, as the country of the log in attempt of the terminal 100. Referring to FIG. 6, of the extracted country information, since there are two ‘A country’, and one ‘B country’, ‘A country’ may be selected as the country of the log in attempt of the terminal 100.

In order to determine whether to allow the log in of the terminal 100, the processor 430 may read the country information received from the terminal 100 when subscribing the video call service, from the memory 420.

The processor 430 may compare the country of the log in attempt of the terminal 100 with the country information read from the memory 420. For example, the country information read from the memory 420 may be ‘A country’. The processor 430 may check that the country of the log in attempt of the terminal 100 and the read country information are both ‘A country’. Therefore, the processor 430 may allow the log in of the terminal 100.

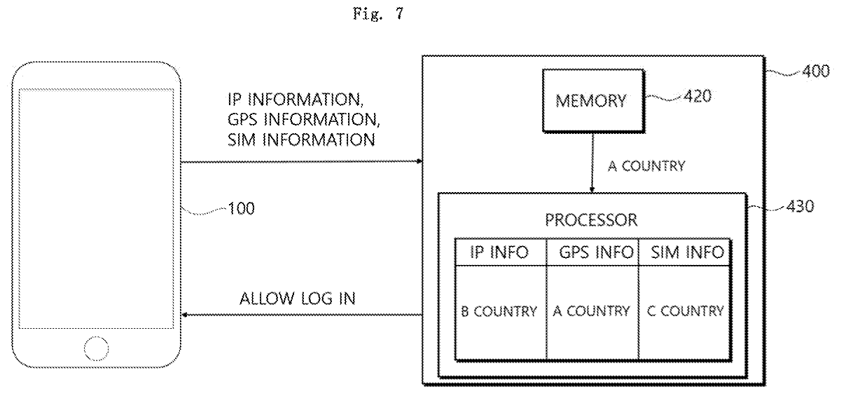

FIG. 7 is a view illustrating a method in which the server allows the log in of the terminal according to another embodiment of the present disclosure.

Referring to FIGS. 3, 4, and 7, at a request of the server 400, the terminal 100 may transmit the information for determining the country of the log in attempt, to the server 400. For example, the information for determining the country of the log in attempt may be the IP information, GPS information, and SIM information of the terminal 100.

The processor 430 may extract the information of the region where the terminal 100 is located, from the received IP information. For example, the regional information extracted from the IP information may be ‘B country’. The processor 430 may extract the GPS coordinates from the GPS information. For example, the regional information extracted from the GPS information may be ‘A country’. In addition, the processor 430 may extract the country information from the SIM information. For example, the country information extracted from the SIM information may be ‘C country’.

In some embodiments, the country information extracted from each of the IP information, GPS information, and SIM information may be different from one another. In a case where the extracted country information are all different, the processor 430 may select one of the different country information as the country of the log in attempt of the terminal 100. For example, the processor 430 may give weights having different values to the different country information based on a certain criterion.

In some embodiments, the processor 430 may give a high weight to the information that is expected to have a high reliability. For example, the processor 430 may give the highest weight to the GPS information, the next highest weight to the SIM information, and the next highest weight to the IP information. The method described above is only an example, and the processor 430 may give weights having different values to different country information based on reliability. In addition, the processor 430 may give the weights having different values to different country information based on other criteria besides reliability.

The user of the terminal 100 can manipulate the IP information using a Virtual Private Network (VPN) bypass application or manipulate the SIM information using a SIM card of another country, and therefore, the IP information and SIM information may be determined to have lower reliability than the GPS information.

In order to determine whether to allow the log in of the terminal 100, the processor 430 may read the country information received from the terminal 100 when subscribing the video call service, from the memory 420.

The processor 430 may compare the country of the log in attempt of the terminal 100 with the country information read from the memory 420. For example, the country information read from the memory 420 may be ‘A country’. The processor 430 may check that the country of the log in attempt of the terminal 100 and the read country information are both ‘A country’. Therefore, the processor 430 may allow the log in of the terminal 100.

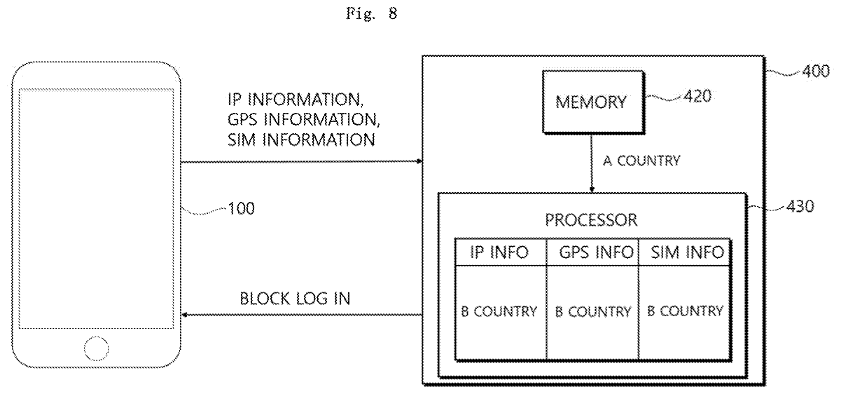

FIG. 8 is a view illustrating a method in which the server blocks the log in of the terminal according to an embodiment of the present disclosure.

Referring to FIGS. 3, 4, and 8, at a request of the server 400, the terminal 100 may transmit the information for determining the country of the log in attempt, to the server 400. For example, the information for determining the country of the log in attempt may be the IP information, GPS information, and SIM information of the terminal 100.

From the received IP information, the processor 430 may extract the information of the region where the terminal 100 is located. For example, the regional information extracted from the IP information may be ‘B country’. The processor 430 may extract the GPS coordinates from the GPS information. For example, the regional information extracted from the GPS information may be ‘B country’. The processor 430 may extract the country information from the SIM information. For example, the country information extracted from the SIM information may be ‘B country’.

Since the country information extracted from each of the IP information, GPS information, and SIM information is ‘B country’, the processor 430 may determine that the country of the log in attempt of the terminal 100 is ‘B country’.

In order to determine whether to allow the log in of the terminal 100, the processor 430 may read the country information received from the terminal 100 when subscribing the video call service, from the memory 420.

The processor 430 may compare the country of the log in attempt of the terminal 100 with the country information read from the memory 420. For example, the country information read from the memory 420 may be ‘A country’. On the other hand, the country of the log in attempt of the terminal 100 is ‘B country’. Since the country of the log in attempt of the terminal 100 is different from the read country information, the processor 430 may determine that the user of the terminal 100 made the log in attempt in a country other than the country where the user subscribed the video call service. Therefore, the processor 430 may block the log in of the terminal 100.

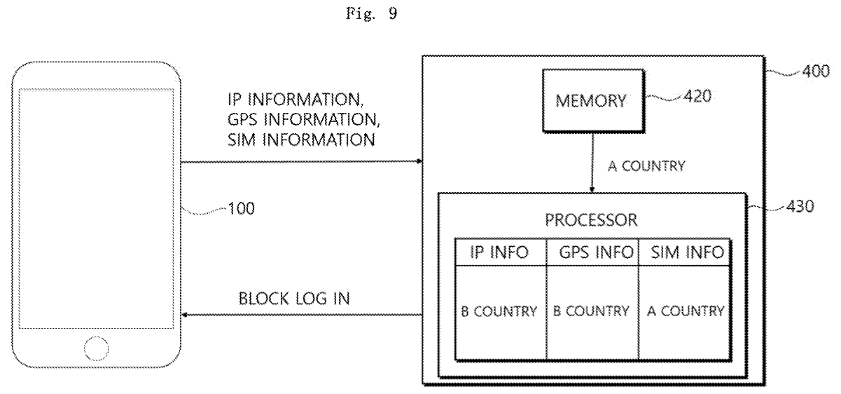

FIG. 9 is a view illustrating a method in which the server blocks the log in of the terminal according to another embodiment of the present disclosure.

Referring to FIGS. 3, 4, and 9, at a request of the server 400, the terminal 100 may transmit the information for determining the country of the log in attempt, to the server 400. For example, the information for determining the country of the log in attempt may be the IP information, GPS information, and SIM information of the terminal 100.

The processor 430 may extract the information of the region where the terminal 100 is located, from the received IP information. For example, the regional information extracted from the IP information may be ‘B country’. The processor 430 may extract the GPS coordinates from the GPS information. For example, the regional information extracted from the GPS information may be ‘B country’. Further, the processor 430 may extract the country information from the SIM information. For example, the country information extracted from the SIM information may be ‘A country’.

The country information extracted from each of the IP information and GPS information may be ‘B country’, and the country information extracted from the SIM information may be ‘A country’. In some embodiments, in a case where there are two or more extracted country information, the processor 430 may select one of the two or more country information as the country of the log in attempt of the terminal 100. For example, the processor 430 may select the country information, which is the same among the most number of the two or more country information, as the country of the log in attempt of the terminal 100. Referring to FIG. 9, of the extracted country information, since there are two ‘B country’, and one ‘A country’, ‘B country’ may be selected as the country of the log in attempt of the terminal 100.

In order to determine whether to allow the log in of the terminal 100, the processor 430 may read the country information received from the terminal 100 when subscribing the video call service, from the memory 420.

The processor 430 may compare the country of the log in attempt of the terminal 100 with the country information read from the memory 420. For example, the country information read from the memory 420 may be ‘A country’. On the other hand, the country of the log in attempt of the terminal 100 is ‘B country’. Since the country of the log in attempt of the terminal 100 is different from the read country information, the processor 430 may determine that the user of the terminal 100 made the log in attempt in a country other than the country where the user subscribed the video call service. Therefore, the processor 430 may block the log in of the terminal 100.

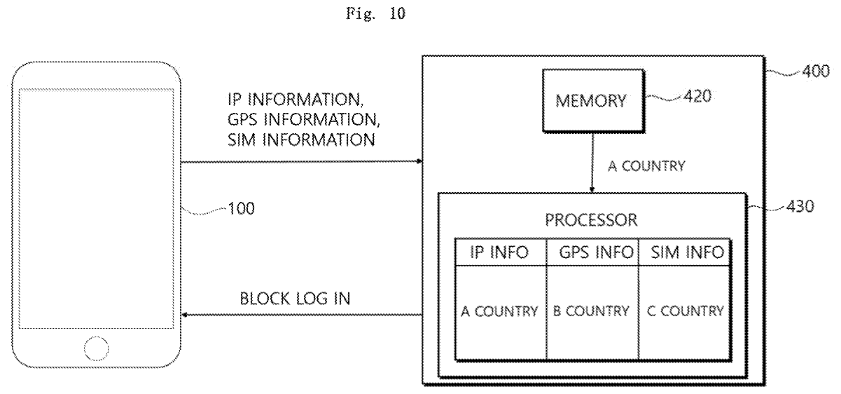

FIG. 10 is a view illustrating a method in which the server blocks the log in of the terminal according to another embodiment of the present disclosure.

Referring to FIGS. 3, 4, and 10, at a request of the server 400, the terminal 100 may transmit information for determining the country of the log in attempt, to the server 400. For example, the information for determining the country of the log in attempt may be the IP information, GPS information, and SIM information of the terminal 100.

From the received IP information, the processor 430 may extract the information of the region where the terminal 100 is located. For example, the regional information extracted from the IP information may be ‘A country’. The processor 430 may extract the GPS coordinates from the GPS information. For example, the regional information extracted from the GPS information may be ‘B country’. In addition, the processor 430 may extract the country information from the SIM information. For example, the country information extracted from the SIM information may be ‘C country’.

In some embodiments, the country information extracted from each of the IP information, GPS information, and SIM information may be different from one another. In a case where the extracted country information are all different, the processor 430 may select one of the different country information as the country of the log in attempt of the terminal 100. For example, the processor 430 may give weights having different values to the different country information based on a certain criterion. For example, the processor 430 may give the weights to the information in a similar or identical method as the method described above with reference to FIG. 7.

In order to determine whether to allow the log in of the terminal 100, the processor 430 may read the country information received from the terminal 100 when subscribing the video call service, from the memory 420.

The processor 430 may compare the country of the log in attempt of the terminal 100 with the country information read from the memory 420. For example, the country information read from the memory 420 may be ‘A country’. On the other hand, the country of the log in attempt of the terminal 100 is ‘B country’. Since the country of the log in attempt of the terminal 100 is different from the read country information, the processor 430 may determine that the user made the log in attempt in a country other than the country where the user subscribed the video call service. Therefore, the processor 430 may block the log in of the terminal 100.

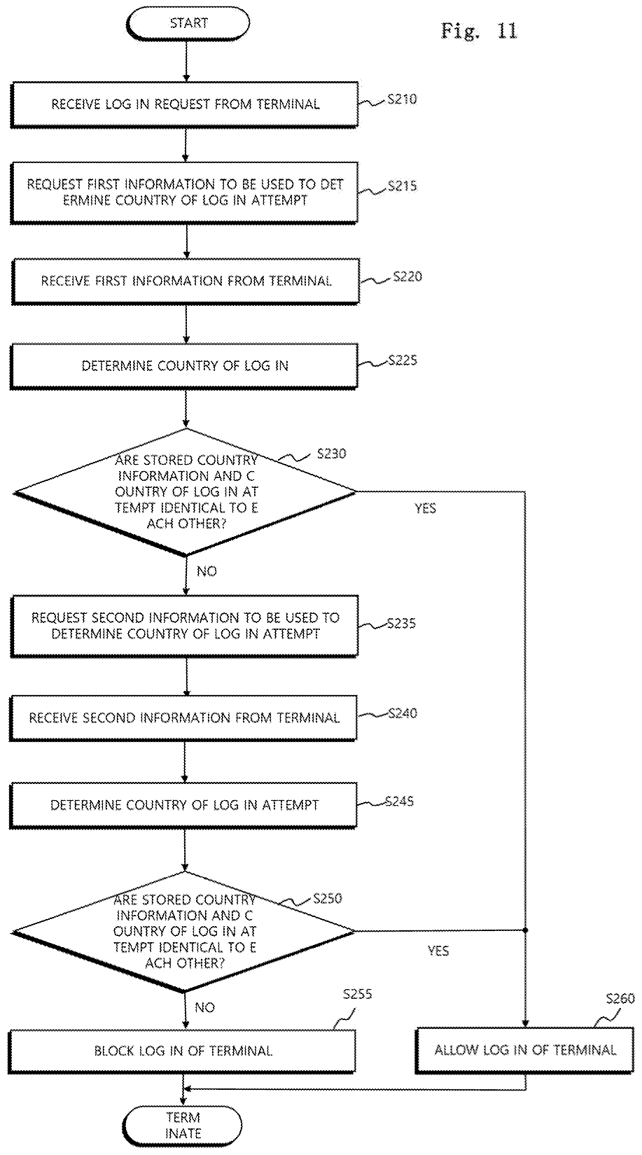

FIG. 11 is a block diagram illustrating the operating method of the server according to another embodiment of the present disclosure.

At step S210, the communication interface 410 of the server 400 may receive a log in request from the first terminal 100. For example, the server 400 may execute an application that provides video call services through the communication interface 410.

At step S215, the processor 430 of the server 400 may request information for determining in which country the first terminal 100 attempted to log in. The processor 430 may transmit the request to the first terminal 100 through the communication interface 410.

At step S220, in response to the request, the processor 430 of the server 400 may receive a first information from the first terminal 100. For example, the first information may include the IP address, GPS information, and SIM information. The IP address, GPS information, and SIM information may be traced through the communication interface 410 of the server 400.

At step S225, the processor 430 of the server 400 may determine the country in which the first terminal 100 made the log in attempt based on the received first information. More specifically, the processor 430 may determine the country of the log in attempt of the first terminal 100 based on the IP address, GPS information, and SIM information.

At step S230, the processor 430 of the server 400 may check whether the country information stored in the memory 420 and the determined country information are identical to each other. If it is determined that the stored country information and the determined country information are identical to each other, at step S260, the processor 430 of the server 400 may allow the log in of the first terminal 100. In some embodiments, the processor 430 may determine that the stored country information and the determined country information are identical to each other in a similar or identical method as described above with reference to FIGS. 5 to 7.

On the contrary, in a case where it is determined that the stored country information and the determined country information are different from each other, at step S235, the processor 430 of the server 400 may request information for determining the location of the country in which the first terminal 100 made the log in attempt. In some embodiments, the processor 430 may determine that the stored country information and the determined country information are different from each other in a similar or identical method as described above with reference to FIGS. 8 to 10.

At step S240, in response to a request, the processor 430 of the server 400 may receive a second information from the first terminal 100. For example, the second information may be the time information and locale information set in the first terminal 100. The time information may be information about the time automatically set in the terminal 100 based on the GPS information. The locale information may include the country and language set in the terminal 100.

At step 245, the processor 430 of the server 400 may determine the country in which the first terminal 100 made the log in attempt based on the received second information. More specifically, the processor 430 may determine the country of the log in attempt of the first terminal 100 based on the time information and locale information of the terminal 100.

At step S250, the processor 430 of the server 400 may check whether the country information stored in the memory 420 and the determined country information are identical to each other. If it is determined that the stored country information and the determined country information are different from each other, at step S255, the processor 430 of the server 400 may block the log in of the first terminal 100.

On the contrary, in a case where it is determined that the stored country information and the determined country information are identical to each other, at step S260, the processor 430 of the server 400 may allow the log in of the first terminal 100.

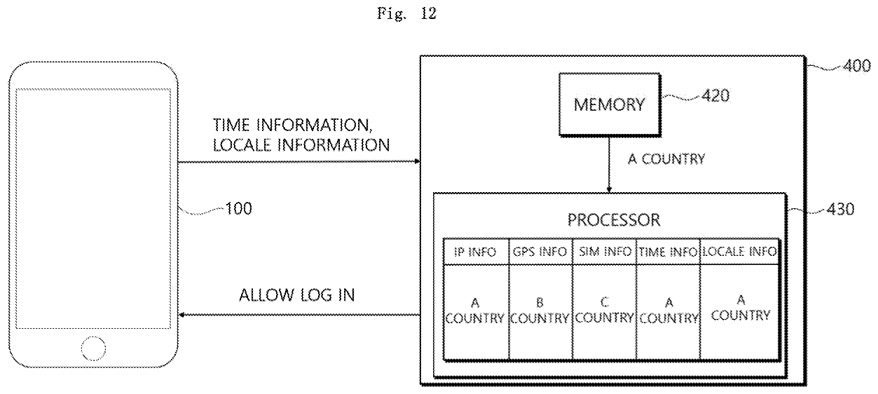

FIG. 12 is a view illustrating a method in which the server allows the log in of the terminal using additional information according to an embodiment of the present disclosure.

Referring to FIGS. 10 and 12, in a case where the country of the log in attempt of the terminal country (for example, ‘B country’) determined based on the country information extracted from the IP information (for example, ‘A country’), the country information extracted from the GPS information (for example, ‘B country’), and the country information extracted from the SIM information (for example, ‘C country’), received from the terminal 100, is different from the country information read from the memory (for example, ‘A country’), the processor 430 may receive additional information from the terminal 100. In some embodiments, the processor 430 may receive the time information and locale information set in the terminal 100 as the additional information.

In some embodiments, the IP information, GPS information, and SIM information received from the terminal 100 may be the first information, and the time information and locale information received from the terminal 100 may be the second information.

In some embodiments, the processor 430 may extract the country information from the time information received from the terminal 100. More specifically, the processor 430 may infer the country where the terminal 100 is located based on the time information set in the terminal 100. However, it may be difficult to determine the exact country location only with the time information. For example, since Korea and Japan use the same time zone, it may be difficult for the processor 430 to determine the exact country information where the terminal 100 is located only with the time information of the terminal 100 located in Korea.

The processor 430 may infer the exact country information additionally using the locale information. For example, the locale information may include the country information and language information set in the terminal 100. For example, using the time information, the processor 430 may determine that the country where the terminal 100 is located is Korea or Japan. In addition, upon using the locale information of the terminal 100 to check that the language information set in the terminal 100 is Korean, the processor 430 may finally determine that the country where the terminal 100 is located is Korea.

Referring to FIG. 12, the country information which the processor 430 extracted from each of the time information and locale information may be ‘A country’. Therefore, the processor 430 may determine that the country of the log in of the terminal 100 is ‘A country’.

The processor 430 may compare the country of the log in attempt of the terminal 100 with the country information read from the memory 420. For example, the country information read from the memory 420 may be ‘A country’. The processor 430 may check that the country of the log in attempt of the terminal 100 and the read country information are both ‘A country’. Therefore, the processor 430 may allow the log in of the terminal 100.

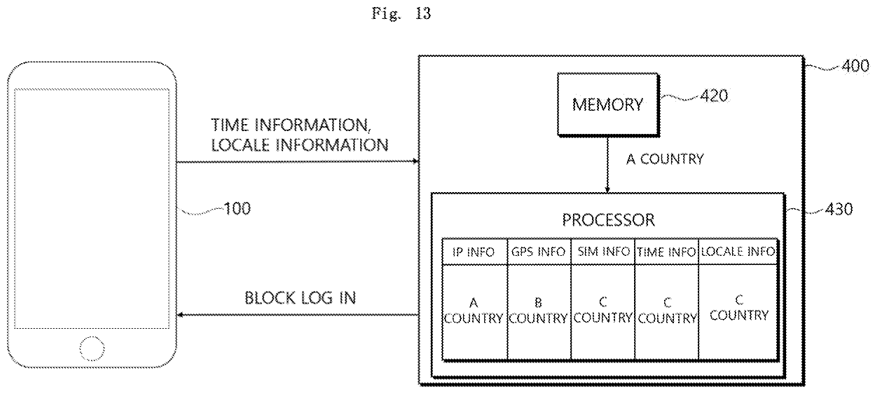

FIG. 13 is a view illustrating a method in which the terminal blocks the log in of the terminal using the additional information according to an embodiment of the present disclosure.

Referring to FIGS. 10 and 13, in a case where the country of the log in attempt of the terminal country (for example, ‘B country’) determined based on the information extracted from the IP information (for example, ‘A country’), the country information extracted from the GPS information (for example, ‘B country’), and the country information extracted from the SIM information (for example, ‘C country’), received from the terminal 100, is different from the country information read from the memory (for example, ‘A country’), the processor 430 may receive additional information from the terminal 100. In some embodiments, the processor 430 may receive the time information and locale information set in the terminal 100 as the additional information.

In some embodiments, the IP information, GPS information, and SIM information received from the terminal 100 may be the first information, and the time information and locale information received from the terminal 100 may be the second information.

The country information that the processor 430 extracted from each of the time information and locale information may be ‘C country’. FIG. 13 illustrates that the country information extracted from the time information is ‘C country’, but the processor 430 may extract a neighboring country of ‘C country’ (for example, ‘D country’ or ‘E country’) as the country information based on the time information.

In a case where the information extracted based on the country and language information included in the locale information is ‘C country’, the processor 430 may determine that the country of the log in attempt of the terminal 100 is ‘C country’.

The processor 430 may compare the country of the log in attempt of the terminal with the country information read from the memory 420. For example, the country information read from the memory 420 may be ‘A country’. On the other hand, the country of the log in attempt of the terminal 100 is ‘C country’. Since the country of the log in attempt of the terminal and the read country information are different from each other, the processor 430 may determine that the user of the terminal 100 made the log in attempt in a country other than where the user subscribed the video call service. Therefore, the processor 430 may block the log in of the terminal 100.

The embodiments described above may also be implemented in the form of a record medium that includes instructions executable by a computer such as program modules executable by a computer. The computer readable medium may be any available media that can be accessed by a computer, and may include both volatile and nonvolatile media, and removable and non-removable media.

Further, the computer readable medium may include a computer storage medium or a communication medium. The computer storage medium may include both volatile and nonvolatile, and removable and non-removable medium implemented in any method or technology for storage of information such as computer readable instructions, data structures, program modules or other data. Communication media typically include computer readable instructions, data structures, program modules, or other data in a modulated data signal, such as a carrier wave, or other output mechanism, and may include any information delivery media.

Embodiments of the present disclosure were explained with reference to the drawings attached hereto, but a person skilled in the art will understand that the present disclosure may be implemented in other specific forms without changing its technical idea or essential characteristics. Therefore, the embodiments disclosed hereinabove must be understood as exemplary and not limiting the present disclosure in all aspects.

What is claimed is:

1. An operating method of a server for providing a video call service, the method comprising:
receiving, from a terminal, a log in request for the video call service;
requesting information to be used in determining a country of the log in request the terminal;
receiving the information from the terminal;
determining the country of the log in request based on the information;
comparing a prestored country information corresponding to the terminal and the determined country of the log in request; and
allowing the log in by the terminal depending on a result of the comparison.

2. The operating method of claim 1,
wherein the information comprises Internet Protocol (IP) address information, Subscriber Identity Module (SIM) information, and Global Positioning System (GPS) information.

3. The operating method of claim 2,
wherein the determining the country of the log in request based on the information comprises:
extracting a first country information from the IP address information, extracting a second country information from the SIM information, and extracting a third country information from the GPS information.

4. The operating method of claim 3,
wherein the determining the country of the log in request based on the information further comprises:
in response to the first country information, the second country information and the third country information being the same, determining a country included in the first to third country information as the country of the log in request.

5. The operating method of claim 3,
wherein the determining the country of the log in request based on the information further comprises:
in response to two or more of the first country information, the second country information, and the third country information including a same country, determining the same country included in the two or more countries information as the country of the log in request.

6. The operating method of claim 3,
wherein the determining the country of the log in request based on the information further comprises:
in response to the first country information, the second country information, and the third country information being different from one another, giving each of the first to third country information a weight of different value, and determining a country included in country information to which the weight is given as the country of the log in request.

7. The operating method of claim 1,
wherein the stored country information is information input by a user of the terminal when subscribing to the video call service.

8. The operating method of claim 1,
wherein the stored country information is information determined using at least one of IP information, GPS information, and SIM information input by a user of the terminal when subscribing to the video call service.

9. The operating method of claim 1,
wherein the allowing the log in of the terminal depending on a result of the comparison comprises:
in response to a country included in the stored country information and the determined country of the log in request being the same as the result of the comparison, allowing the log in of the terminal.

10. The operating method of claim 9,
further comprising, in response to a country included in the stored country information and the determined country of the log in request not being the same as the result of the comparison, blocking the log in of the terminal.

11. The operating method of claim 9,
further comprising, in response to a country included in the stored country information and the determined country of the log in request not being the same as the result of the comparison, requesting additional information to be used to determine the country of the log in request;
determining the country of the log in request based on the additional information;
comparing the country included in the stored country information with the determined country of the log in request; and
allowing the log in of the terminal depending on the result of the comparison.

12. The operating method of claim 11,
wherein the additional information comprises time information set in the terminal, and locale information comprising country and language information set in the terminal.

13. The operating method of claim 12,
wherein the determining the country of the log in request based on the additional information comprises extracting at least one fourth country information from the time information, and extracting a fifth country information from the locale information.

14. The operating method of claim 13,
wherein the determining the country of the log in request based on the additional information further comprises:
in response to the fourth country information and the fifth country information being the same , determining a country included in the fourth country information and the fifth country information as the country of the log in request.

15. The operating method of claim 11,
wherein the allowing the log in of the terminal depending on the result of the comparison comprises, in response to the country included in the stored country information and the determined country of the log in request being the same as the result of the comparison, allowing the log in of the terminal.

16. The operating method of claim 15,
further comprising, in response to the country included in the stored country information and the determined country of the log in request not being the same as the result of the comparison, blocking the log in of the terminal.

17. A computer readable recording medium having recorded thereon a program for performing a method according to claim 1.

18. A computer readable recording medium having recorded thereon a program for performing a method according to claim 3.

19. A computer readable recording medium having recorded thereon a program for performing a method according to claim 4.

20. A server comprising:
a communication interface receiving a log in request for a video call service from a terminal, and receiving information to be used to determine a country of the log in request;
a memory storing country information received from the terminal when the terminal subscribes to the video call service; and
a processor determining the country of the log in request based on the information, comparing a prestored country information corresponding to the terminal with the determined country of the log in request, and allowing the log in of the terminal depending on a result of the comparison.
